(19) United States
(12) Patent Application Publication
(10) Pub. No.: US 2010/0107326 A1
(43) Pub. Date: May 6, 2010

(54) UNIVERSAL FIT BEDPAN PAD

(76) Inventor: David J. Joseph, Glendale, AZ (US)

Correspondence Address: MESCHKOW & GRESHAM, P.L.C., 7250 NORTH SIXTEENTH STREET, SUITE 318, PHOENIX, AZ, 85020-5279, US

(21) Appl. No.: 12/609,941

(22) Filed: Oct. 30, 2009

Related U.S. Application Data
(60) Provisional application No. 61/110,749, filed on Nov. 3, 2008.

(51) Int. Cl. A61G 9/00

(52) U.S. Cl. 4/457

(57) ABSTRACT

A bedpan pad (40) includes a bendable elongated cushion (42) and a fastener mechanism (44) formed in the cushion (42). The fastener mechanism (44) includes a longitudinally aligned opening (60) extending along a length (58) of the cushion (42). Notches (64) are located on an interior curvature side (66) of the cushion (42). The fastener mechanism (44) is configured to engage with a bedpan (20) via the opening (60) such that the cushion (42) wraps around opposing inner and outer top edges (34, 36) of thigh-support regions (28) of a bedpan (20). The notches (64) close in response to bending of the cushion (42) to provide a smooth surface at regions of greatest curvature of the bedpan (20). The bending capability of the cushion (42), attachment feature of mechanism (44), and notches (64) enable the bedpan pad (40) to fit multiple shapes and sizes of a plurality of bedpans (20).

### RELATED INVENTION

The present invention claims priority under 35 U.S.C. §119(e) to: “Bedpan Pad,” U.S. Provisional Patent Application Ser. No. 61/110,749, filed 3 Nov. 2008, which is incorporated by reference herein.

### TECHNICAL FIELD OF THE INVENTION

The present invention relates generally to a cushioning system for a bedpan. More specifically, the present invention relates to a universal fit bedpan pad adapted to fit a plurality of bedpan shapes and sizes.

### BACKGROUND OF THE INVENTION

Bedpans are frequently used in hospitals, long term care facilities, and in homes by patients who are unable to use conventional toilets. Typically, a bedpan is placed beneath the patient and removed after use by a hospital employee or other caregiver for cleaning and sanitizing.

FIG. 1 shows a top view of a conventional bedpan 20. As shown, bedpan 20 includes a top surface 22 containing an opening into a cavity 24 configured to receive and contain bodily waste. Top surface 22 includes a buttocks-support region 26 and thigh-support regions 28. A handle 30 positioned between the thigh-support regions 26 facilitates placement and removal of bedpan 20 beneath a user.

Buttocks-support region 26 is relatively shallow, whereas a raised sidewall 32 at thigh-support regions 28 results in bedpan 20 increasing in height at thigh-support regions 28 relative to the shallow buttocks-support region 26. The increased height at thigh-support regions 28 relative to buttocks-support region 26 may also be visualized in FIG. 6. The configuration of buttocks-support region 26 allows the user to slide his or her thighs over buttocks-support region 26 to rest them on thigh-support regions 28. The relatively shallow configuration of buttocks-support region permits maneuverability and less lifting by the user, and the increased height of bedpan 20 at thigh-support regions 28 accommodates the natural tendency for the legs to remain slightly elevated and slanted when the lower back is raised such as when the user is seated on buttocks-support region 26 of bedpan 20.

Thigh-support regions 28 of a conventional bedpan, exemplified by bedpan 20, are typically relatively narrow. When a user's thighs rest on the relatively narrow thigh-support regions 28, the weight of the user can cause the flesh on the user's thighs to press into and wrap around thigh-support regions 26 at inner and outer top edges 34 and 36, respectively, of sidewall 32. Accordingly, bedpan 20 can feel hard, cold, and painful on the flesh of the user. For those patients who are especially ill or in a weakened state, a bedpan can cause skin tears, aggravate existing skin tears, or cause other injuries. Due to the discomfort and potential for injury, some individuals would rather use diapers in lieu of a bedpan. Unfortunately, there is a greater risk of urinary tract infections and other types of infections from urine and/or solid waste sitting against the skin inside a diaper.

Therefore what is needed is a cushioning system for a bedpan that enables a user to comfortably use the bedpan, that can limit user injury, that is inexpensive, and that is sanitary.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top view of a conventional bedpan;

FIG. 2 shows a perspective, bottom view of a universal fit bedpan pad in accordance with an embodiment of the invention;

FIG. 3 shows a cross-sectional view of the bedpan pad of FIG. 2;

FIG. 4 shows a top view of the bedpan pad being installed on a bedpan;

FIG. 5 shows a top view of the bedpan with the bedpan pad fully engaged on the bedpan;

FIG. 6 shows a side view of the bedpan with the bedpan pad fully engaged on the bedpan; and

FIG. 7 shows a cross-sectional view of a bedpan pad in accordance with another embodiment of the invention.

### DETAILED DESCRIPTION

Embodiments of the invention comprise a universal fit bedpan pad. The bedpan pad is cushioned for user comfort and is deformable to accommodate various sizes and shapes of bedpans. The bedpan pad can be readily and inexpensively constructed, and can be easily installed on a variety of bedpans. As such, it can be made available for use in hospitals, care facilities, and in homes.

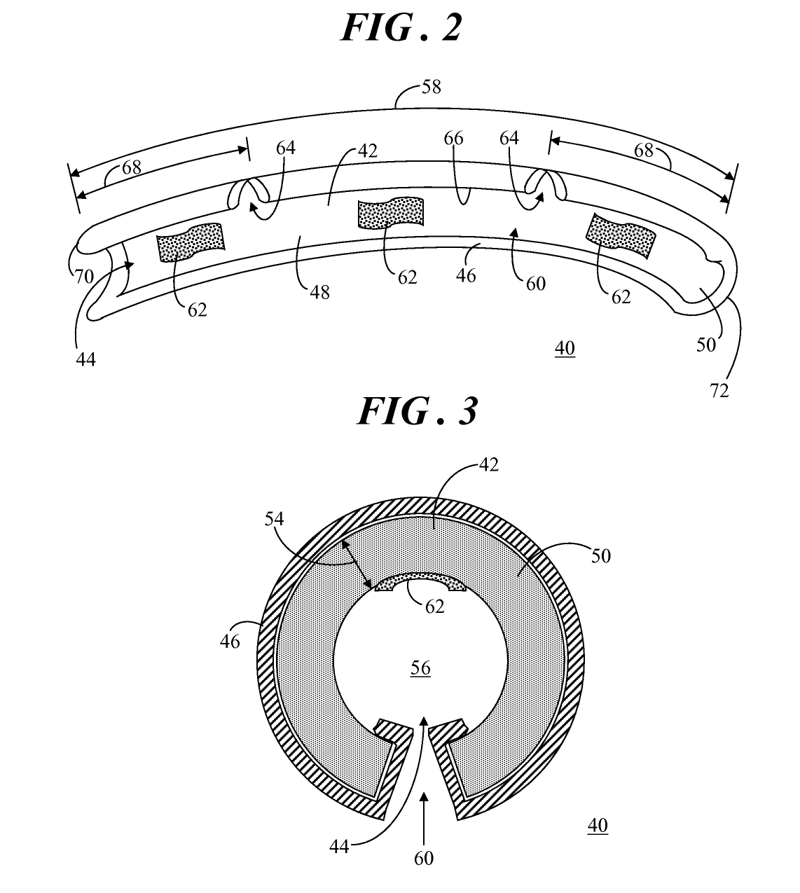

Referring to FIGS. 2-3, FIG. 2 shows a perspective, bottom view of a universal fit bedpan pad 40 in accordance with an embodiment of the invention, and FIG. 3 shows a cross-sectional view of the bedpan pad 40. Bedpan pad 40 generally includes an elongated cushion 42, a fastener mechanism 44 formed in cushion 42, and a cover 46 at least partially enclosing cushion 42.

In an embodiment, elongated cushion 42 is a hollow tubular member 48 having a sidewall 50 of a suitable thickness 54, and an interior cavity 56 extending along a length 58 of hollow tubular member 48. When elongated cushion 42 is not installed on a bedpan, cushion 42 may be relatively straight or only slightly arched. However, elongated cushion 42 is selectively bendable along length 58 of cushion 42 so that elongated cushion 42 may be bent or wrapped around any of a multitude of shapes and sizes of bedpans. Elongated cushion 42 may be formed from a compressible padding material such as polyurethane, foam, cotton fiber, or any other suitable existing or developing padding material.

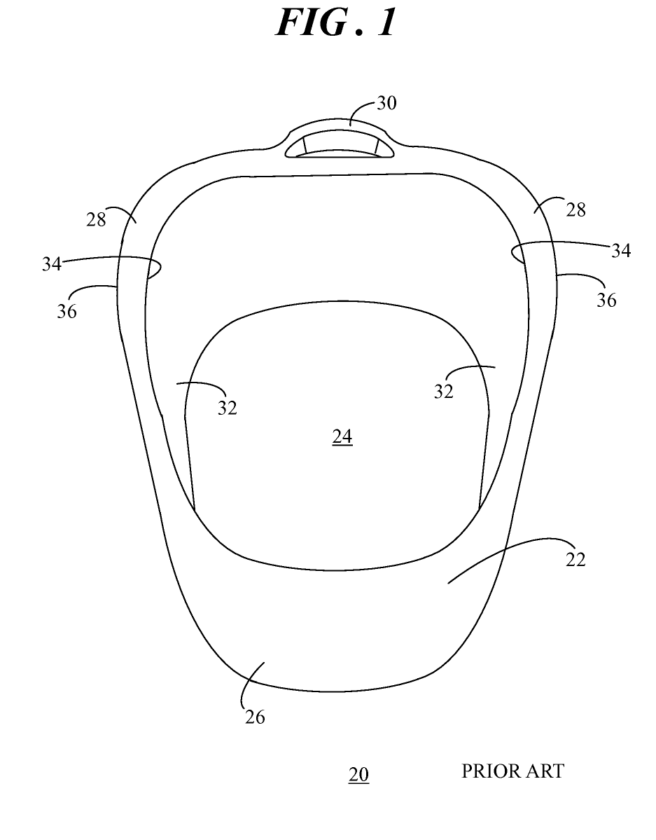

Fastener mechanism 44 formed in cushion 42 includes an opening 60 extending along length 58 of hollow tubular member 48. In an embodiment, opening 60 is a lengthwise or longitudinal slit extending through sidewall 50 to expose interior cavity 56 of elongated cushion 42. As will be explained in greater detail below, cushion 42 may be installed on bedpan 20 (FIG. 1) via opening 60 so that cushion 42 wraps around the opposing inner and outer top edges 34 and 36, respectively, (FIG. 1) of thigh-support regions 28 (FIG. 1).

The shape of hollow tubular member 48 and the configuration of fastener mechanism 44 enable a simple pressure fit and retention of bedpan pad 40 on bedpan 20 for ready installation and removal. However, as illustrated, bedpan pad 40 may optionally further include one or more connectors 62 attached to cushion 42. For example, bedpan pad 20 may be provided with connectors 62 formed from a pressure sensitive adhesive material suitably positioned on sidewall 50 in interior cavity 56 of elongated cushion 42. Connectors 62, in the form of pressure sensitive adhesive material may be protected by a strip of sheet material. When bedpan pad 20 is to be used, this shielding material is removed to expose the adhesive surface of connectors 62. A caregiver can then properly position bedpan pan 20 on thigh-support regions 28 (FIG. 1) so that connectors 62 couple to thigh-support regions 28 to retain bedpan pad 20 in place. Although connectors 62 of pressure sensitive adhesive material are mentioned herein, other connectors may alternatively be implemented such as snaps, hook and loop, elastic, and so forth.

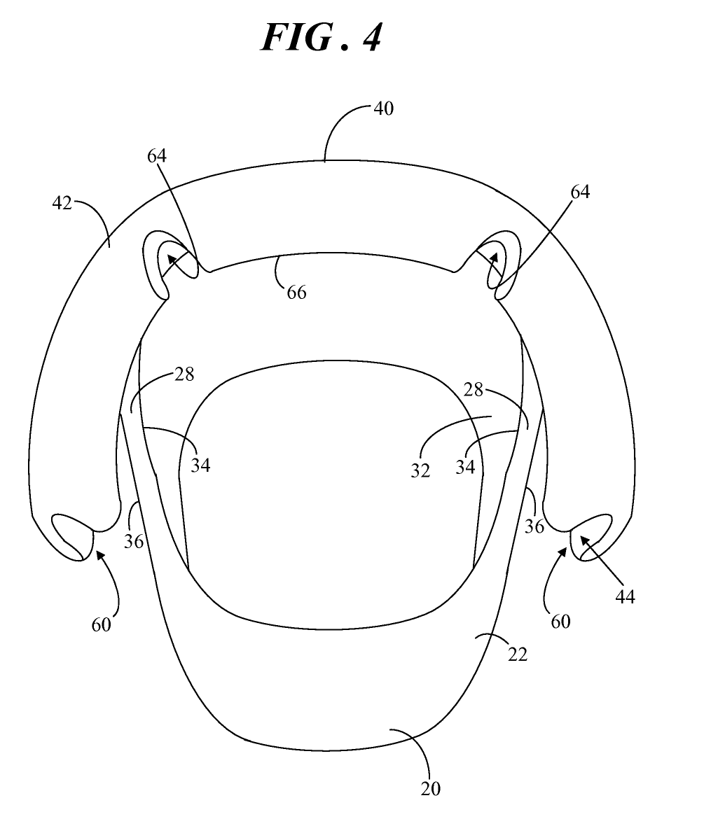

As mentioned previously, cushion 42 is bendable to accommodate a variety of shapes and sizes of bedpans. As elongated cushion 42 bends to adapt to a particular size and shape of any of a variety of bedpans, cushion 42 can pucker and cause an uncomfortable bump or ridge at the locations of greatest curvature. Accordingly, hollow tubular member 48 includes at least one notch 64 extending through a portion of hollow tubular member 48 in order to prevent this puckering of cushioning material. In the illustrated embodiment, hollow tubular member 48 of elongated cushion 42 includes two arch-shaped, or arcuate, notches 64 whose widest portion begin at opening 60 and extend through sidewall 50. Thus, notches 64 are located on an interior curvature side 66 (see also FIG. 4) of elongated cushion 42.

In an embodiment, one notch 64 may be located a distance 68 from a first end 70 of elongated cushion 42, and another notch 64 may be located the same distance 68 from a second end 72 of elongated cushion 42. Distance 68 may be approximately one third of length 58. In effect, notches 64 constitute a removal of material in sidewall 50 at the locations of greatest curvature of the bedpan so that as elongated cushion 42 bends inwardly, notches close, or get smaller. Furthermore, the arched shape of notches 64 results in stronger material properties that are less likely to tear or kink than, for example, triangular notches having suddenly transitioning corners.

Cover 46 may be a thin plastic film such as thin polyethylene, polyvinylchloride polyvinylacetate, cellophane, and so forth that largely encloses those portions of elongated cushion 42 that come into contact with the user. Cover 46 may be moisture resistant and/or can have antimicrobial properties to provide the user with a clean and sanitary surface that will come into contact with their skin. In an embodiment, cover 46 may be a separate material that is wrapped and glued, welded, or otherwise fastened to the exterior surfaces of elongated cushion 42. In another embodiment, elongated cushion 42 may simply be coated with an appropriate gel material that subsequently solidifies around all surfaces of elongated cushion 42 to form cover 46. Those skilled in the art will recognize that cover 46 may include a variety of materials applied using a variety of techniques in order to provide a moisture resistant and/or antimicrobial surface of bedpan pad 40 that will come into contact with the user's skin when it is installed on a bedpan.

FIG. 4 shows a top view of the bedpan pad 40 being installed on bedpan 20. The conventional bedpan 20 is provided for illustrative purposes to in order to depict the use of bedpan pad 40. However, it bears repeating that the particular configuration of bedpan pad 40 enables its use on a multiple shapes and sizes of a plurality of bedpans. Elongated cushion 42 of bedpan pad 40 is bent to fit the curvature of bedpan 20. Opening 60 of fastening mechanism 44 is oriented over and is compelled into engagement with raised sidewall 32 of bedpan 20 at thigh-support regions 28 so that opposing inner and outer top edges 34 and 36 are positioned within interior cavity 56 (FIG. 3) of elongated cushion.

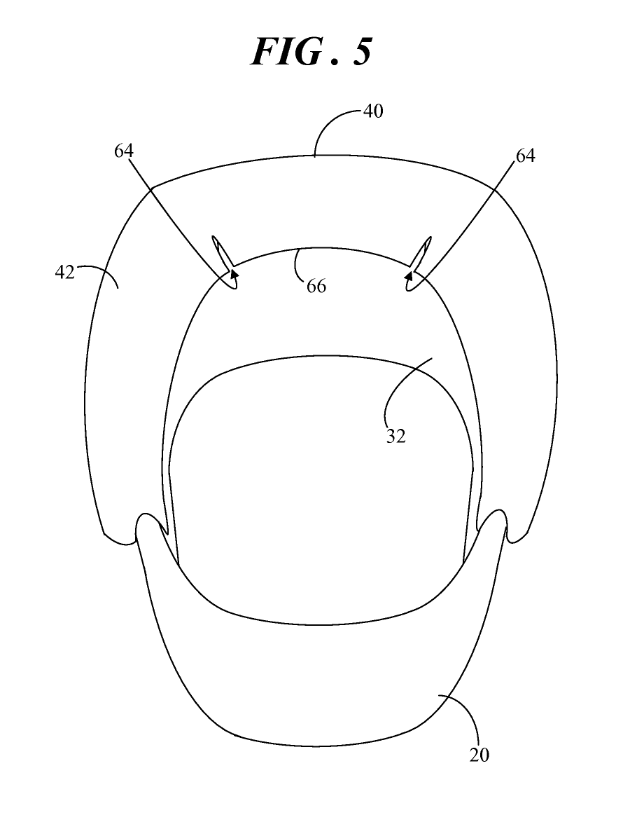

FIG. 5 shows a top view of bedpan 20 with bedpan pad 40 fully engaged on bedpan 20. When bedpan pad 40 is fully engaged on bedpan 20, elongated cushion 42 covers thigh-support regions 28 (FIG. 1) and wraps around inner and outer top edges 34 and 36 (FIG. 1) of raised sidewall 32 of bedpan 20. Furthermore, notches 64 on interior curvature 66 of elongated cushion 42 close, or get smaller, to adapt to the curvature of bedpan 20, thereby preventing material bunching or puckering that might otherwise occur when bedpan pad 40 is engaged on bedpan 20.

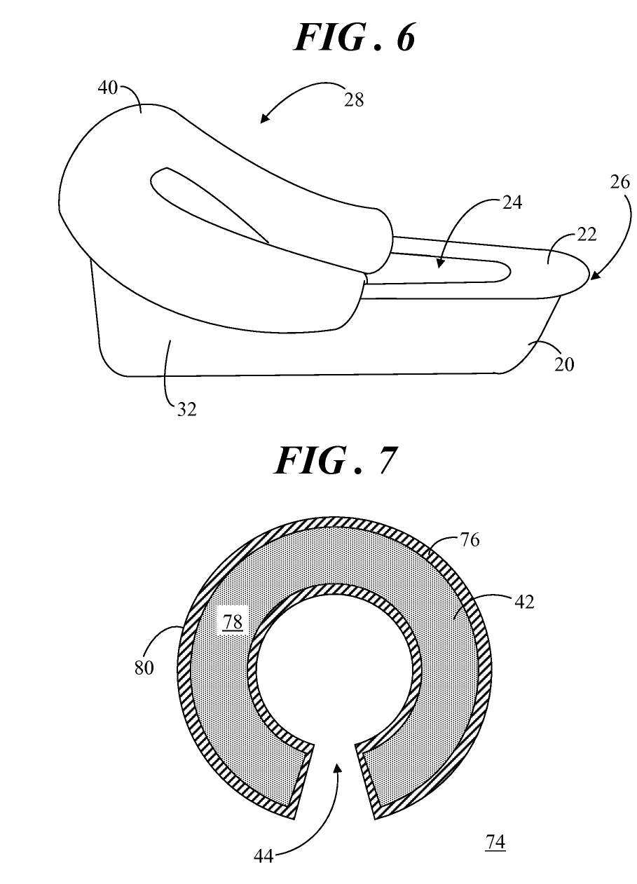

FIG. 6 shows a side view of bedpan 20 with bedpan pad 40 fully engaged on bedpan 20. FIG. 6 reveals the relatively shallow buttocks-support region 26 and the raised sidewall 32 at thigh-support regions 28 that results in the increasing height of bedpan 20 at thigh-support regions. Again, this configuration allows the user to slide his or her thighs over buttocks-support region 26 to rest them on thigh-support regions 28 that are now cushioned by bedpan pad 40. The wrap-around structure of bedpan pad 40 increases user comfort by preventing the flesh on the user's thighs from pressing into and wrapping around thigh-support regions 26 at inner and outer top edges 34 and 36, respectively, (FIG. 1) of sidewall 32.

FIG. 7 shows a cross-sectional view of a bedpan pad 74 in accordance with another embodiment of the invention. Bedpan pad 74 includes elongated cushion 42 and fastening mechanism 44 (FIG. 2) as discussed in detail above. Bedpan pad 74 further includes a cover 76 that fully encloses elongated cushion 42.

In the embodiment illustrated in FIG. 7, cover 76 is formed as a continuous hollow structure shaped to include fastener mechanism 44 (FIG. 2). That is, the continuous hollow structure may be a C-shaped or U-shaped construct that includes a sealed internal cavity 78 and an exterior surface 80. Internal cavity 78 may be filled with a compressible fluid material or gel that is injected into internal cavity 78 to form elongated cushion 42. In alternative embodiments, internal cavity 78 of cover 76 may be filled with a padding or wadding material, foamed material in granular form, a cellulosic padding material such as that commonly used for disposable materials, and so forth.

In summary, embodiments of the invention entail a universal fit bedpan pad that is cushioned for user comfort and is bendable to accommodate the multiple shapes and sizes of a plurality of bedpans. The bedpan pad wraps around opposing edges of thigh-support regions in order to protect the flesh of the user. In addition, the bedpan pad includes notches, or regions of material absence, so that the bedpan pad does not pucker or bunch up at the locations on the bedpan of greatest curvature. The cushioned nature of the bedpan pan is comfortable for to use and can limit injuries, and/or limit aggravation to existing injuries, such as skin tears. Thus, individuals may be more willing to use a bedpan, rather than the less sanitary diapers. In addition, the bedpan pad can be readily and inexpensively constructed, and can be easily installed on a variety of bedpans. As such, it can be made available for use in hospitals, care facilities, and in homes.

Although the preferred embodiments of the invention have been illustrated and described in detail, it will be readily apparent to those skilled in the art that various modifications may be made therein without departing from the spirit of the invention or from the scope of the appended claims. For example, although the elongated cushion is described as a hollow tubular structure having a slit or opening formed through it, the cushion may alternatively be formed as a U-shaped or C-shaped molded structure.

What is claimed is:

1. A universal fit bedpan pad comprising:
an elongated cushion that is selectively bendable along a length of said elongated cushion to adapt to multiple shapes and sizes of a plurality of bedpans; and
a fastener mechanism formed in said elongated cushion, said fastener mechanism including a longitudinally aligned opening extending along said length of said elongated cushion that exposes an interior of said cushion, said fastener mechanism being configured to engage with any of said plurality of bedpans such that said cushion wraps around opposing inner and outer top edges of a flesh engaging portion of said any of said bedpans.

2. A universal fit bedpan pad as claimed in claim 1 wherein:
said elongated cushion comprises a hollow tubular member; and
said opening of said fastener mechanism includes a slit longitudinally extending through a sidewall of said hollow tubular member to expose said interior of said cushion, said elongated cushion being adapted to engage with said flesh engaging portion of said any of said bedpans via said slit.

3. A universal fit bedpan pad as claimed in claim 1 wherein said fastener mechanism further comprises a connector attached to said elongated cushion and adapted to retain said elongated cushion in place around said opposing outer and inner top edges of said flesh engaging portion of said any of said bedpans.

4. A universal fit bedpan pad as claimed in claim 3 wherein said connector is selected from a group comprising snaps, adhesive material, hook and loop, and elastic.

5. A universal fit bedpan pad as claimed in claim 1 wherein said elongated cushion comprises at least one notch extending through a portion of said elongated cushion, said notch being located on an interior curvature side of said elongated cushion.

6. A universal fit bedpan pad as claimed in claim 5 wherein said at least one notch comprises:
a first notch located approximately one third said length of said elongated cushion from a first end of said elongated cushion; and
a second notch located approximately one third said length of said elongated cushion from a second end of said elongated cushion.

7. A universal fit bedpan pad as claimed in claim 5 wherein said notch is arcuate in shape.

8. A universal fit bedpan pad as claimed in claim 5 wherein said elongated cushion comprises a hollow tubular member, said opening of said fastening mechanism includes a slit longitudinally extending through a sidewall of said hollow tubular member to expose said interior of said cushion, and said notch is formed in said sidewall from a portion of said slit.

9. A universal fit bedpan pad as claimed in claim 1 further comprising a cover enclosing said elongated cushion.

10. A universal fit bedpan pad as claimed in claim 9 wherein said cover is formed from a moisture resistant material.

11. A universal fit bedpan pad as claimed in claim 9 wherein:
said cover is formed as a continuous hollow structure shaped to include said fastener mechanism, said hollow structure including a sealed internal cavity and an exterior surface; and
said elongated cushion comprises a compressible fluid material injected into said sealed internal cavity.

12. A universal fit bedpan pad as claimed in claim 1 wherein said elongated cushion is formed from a compressible padding material.

13. A universal fit bedpan pad comprising:
an elongated cushion that is selectively bendable along a length of said elongated cushion to adapt to multiple shapes and sizes of a plurality of bedpans, said elongated cushion comprising:
a hollow tubular member having a sidewall and an interior; and
at least one notch extending through said sidewall of said hollow tubular member, said notch being located on an interior curvature side of said elongated cushion; and
a fastener mechanism formed in said elongated cushion, wherein said fastener mechanism includes a slit longitudinally extending through said sidewall of said hollow tubular member along a length of said hollow tubular member to expose said interior of said hollow tubular member, said fastener mechanism being configured to engage with any of said plurality of bedpans via said slit such that said interior of said hollow tubular member wraps around opposing inner and outer top edges of a flesh engaging portion of said any of said plurality of bedpans.

14. A universal fit bedpan pad as claimed in claim 13 wherein said at least one notch comprises:
a first notch located approximately one third said length of said elongated cushion from a first end of said elongated cushion; and
a second notch located approximately one third said length of said elongated cushion from a second end of said elongated cushion.

15. A universal fit bedpan pad as claimed in claim 14 wherein said notch is arcuate in shape.

16. A universal fit bedpan pad as claimed in claim 13 further comprising a cover enclosing said elongated cushion.

17. A universal fit bedpan pad comprising:
an elongated cushion that is selectively bendable along a length of said elongated cushion to adapt to multiple shapes and sizes of a plurality of bedpans, said elongated cushion including at least one notch extending through a portion of said elongated cushion, said notch being located on an interior curvature side of said elongated cushion;
a fastener mechanism formed in said elongated cushion, said fastener mechanism including a longitudinally aligned opening extending along said length of said elongated cushion that exposes an interior of said cushion, said fastener mechanism being configured to engage with any of said plurality of bedpans such that said cushion wraps around opposing inner and outer top edges of a flesh engaging portion of said any of said bedpans; and
a cover enclosing said elongated cushion.

18. A universal fit bedpan pad as claimed in claim 17 wherein said elongated cushion comprises:
a first notch located approximately one third said length of said elongated cushion from a first end of said elongated cushion; and
a second notch located approximately one third said length of said elongated cushion from a second end of said elongated cushion, each of said first and second notches being arcuate in shape.

19. A universal fit bedpan pad as claimed in claim 17 wherein said cover is formed from a moisture resistant material.
